(19) United States
(12) Patent Application Publication
(10) Pub. No.: US 2024/0343562 A1
(43) Pub. Date: Oct. 17, 2024

(54) METHOD AND FACILITY FOR CONVERSION OF AMMONIA AND METHANOL INTO HYDROGEN USING ROTARY GENERATED THERMAL ENERGY

(71) Applicant: COOLBROOK OY, Helsinki (FI)

(72) Inventors: Reetta KAILA, Helsinki (FI); Elina NAUHA, Helsinki (FI); Anders SIGGBERG, Helsinki (FI)

(21) Appl. No.: 18/622,733

(22) Filed: Mar. 29, 2024

Related U.S. Application Data
(60) Provisional application No. 63/495,644, filed on Apr. 12, 2023.

(51) Int. Cl. C01B 3/04; C01B 3/24

(52) U.S. Cl. CPC C01B 3/047; C01B 3/24; C01B 2203/0233; C01B 2203/0266; C01B 2203/0833; C01B 2203/1223; C01B 2203/1614

(57) ABSTRACT

A method for thermal or thermochemical conversion of ammonia or methanol feedstocks into hydrogen (gas) in a related feedstock conversion facility is provided. The method comprises generating heated fluidic medium by at least one rotary apparatus, supplying a stream of thus generated heated fluidic medium into the feedstock conversion facility, and operating said at least one rotary apparatus and said feedstock conversion facility to carry out thermal or thermochemical conversion of the ammonia or methanol feedstocks into hydrogen at temperatures essentially equal to or exceeding about 500 degrees Celsius (° C.). Facility for production of hydrogen from ammonia or methanol feedstocks is further provided.

### FIELD OF THE INVENTION

The present invention generally relates to methods and systems for thermal or thermochemical conversion of sustainable hydrogen carriers into hydrogen. In particular, the invention relates to producing hydrogen from ammonia- or methanol feedstocks using rotary generated thermal energy.

### BACKGROUND

Hydrogen is a clean fuel, and it has been widely considered as an alternative energy source playing an important role in a sustainable energy future. Hydrogen is presently produced by the reforming of fossil fuels. Hence, application of renewable energy, as well as capture of carbon dioxide from current fossil-based hydrogen production is required in order to reduce the dependency of the technology from fossil-derived sources. However, integration of hydrogen production into existing networks adapted to generate renewable energy, such as solar- or wind energy stations, for example, is far from optimal and lacks a developed infrastructure, making storage and transport of hydrogen difficult and costly.

Hydrogen has low boiling point and volumetric energy density, which causes significant difficulties in liquefaction and compression processes. Therefore, using hydrogen carriers—compounds containing hydrogen—provides a feasible solution for hydrogen storage and transportation. Hydrogen can be released from such carrier compounds by conversion or decomposition reactions. Still, hydrogen carrier compounds must have high hydrogen content, satisfy safety requirements and be suitable for mass production.

Ammonia (NH₃) has high hydrogen content and can be provided as a liquid under mild conditions (−33.3° C. at atmospheric pressure, or 8.46 atm at room temperature (20° C.)). Handling and transport systems for ammonia are well-established, which makes ammonia an attractive hydrogen carrier compound.

Decomposition of ammonia to hydrogen is a reverse of its synthesis reaction and proceeds according to an endothermic reaction described by Equation 1:

$${{NH}_{3} ⇌ {N}_{2} + 3 {H}_{2} , ΔH}_{298 K} = 92 kJ / mol \qquad ( 1 )$$

This conversion depends on the reaction temperature and on the presence of catalyst. Thus, almost full (>99%) thermal conversion of ammonia to hydrogen occurs at temperatures above 500° C. under normal atmospheric pressure (101.3 kPa or 1 atm). After that the reaction is considered irreversible and less dependent on temperature. At temperatures below 500° C. the speed of reaction is very slow, and typically a catalyst is needed to achieve conversion equilibrium. The catalytic ammonia conversion rate depends on such factors as temperature and pressure of the process, composition and specific surface area of the catalyst on which the reaction proceeds, etc. The gas phase ammonia is adsorbed by the catalyst surface, and decomposes to hydrogen and nitrogen. Desorption of nitrogen from the catalyst surface is a rate-limiting step of the process which increases residences time and requires catalysts with large surface area.

On the other hand, methanol (liquid at room temperature and atmospheric pressure) has been investigated as a potential hydrogen carrier compound due to its suitability for mass production and well-established methods for handling and transportation.

Steam reforming of methanol is an endothermic process with preferable efficiency to produce hydrogen. This process generates more moles of hydrogen for every mole of methanol when compared to other known methods, such as an oxidation method, for example. Primary reaction of methanol steam reforming is described with the Equation 2. Other reactions involved in methanol steam reforming are methanol decomposition (Equation 3) and a Water-Gas Shift (WGS) reaction (Equation 4). Reactions 2-4 may occur simultaneously.

$$C {H}_{3} OH + {H}_{2} O ⇌ 3 {H}_{2} + {CO}_{2} , {Δ H}_{298 K} = 49.5 kJ / mol \qquad ( 2 )$$

$${CH}_{3} OH ⇌ 2 {H}_{2} + CO , {Δ H}_{298 K} = 90.1 kJ / mol \qquad ( 3 )$$

$${H}_{2} O + CO ⇌ {CO}_{2} + {H}_{2} , Δ {H}_{298 K} = - 4 \; 12 kJ / mol \qquad ( 4 )$$

Similar to ammonia, methanol decomposition processes also depend on temperature and the presence of catalyst. Thus, although methanol steam reforming can be performed, in presence of catalyst, at temperatures within a range of 150-350° C., in order to achieve considerable conversion without catalyst, temperatures of 650-750° C. are required.

Above mentioned processes utilize various reactor technologies, such as fluidized bed reactors, membrane reactors, continuous tubular reactors, etc.

However, existing heating technologies used to achieve high temperatures in high-temperature processes, such as pyrolysis and reforming are hindered with some common problems. In thermal and thermocatalytic decomposition, for example, heat required for the process is typically provided by external heaters powered with fossil-derived fuels. Transfer of thermal energy through the reactor walls leads to quick formation of carbonaceous deposits, such as coke and soot, on hot surfaces, which causes operational difficulties and greatly impairs heat transfer. In conventional solutions involving heating the gaseous substances in the reactor or furnace, decomposition processes often proceed in an uncontrolled manner and hance cause fouling of reactor parts.

On the other hand, high temperatures required for hydrogen production from ammonia and methanol feedstocks by means of reforming or pyrolysis processes described herein above generally represent one of the main reasons that restrain electrification of these processes. Although considered a suitable solution to reduce GHG emissions, electrification of the industrial processes remains hindered due to inability of current technologies and existing facility infrastructures to fulfil the needs in achieving sufficiently high temperatures.

A number of rotary solutions have been proposed for heating purposes. Thus, U.S. Pat. No. 11,098,725 B2 (Sanger et al) discloses a hydrodynamic heater pump device operable to selectively generate a stream of heated fluid and/or pressurized fluid. Mentioned hydrodynamic heater pump is designed to be incorporated in an automotive vehicle cooling system to provide heat for warming a passenger compartment of the vehicle and to provide other capabilities, such as window deicing and engine cooling. The disclosed device may also provide a stream of pressurized fluid for cooling an engine. Disclosed technology is based on friction; and, since the fluid to be heated is liquid, the presented design is not suitable for conditions involving extreme turbulence of gas aerodynamics.

U.S. Pat. No. 7,614,367 B1 (Frick) discloses a system and method for flamelessly heating, concentrating or evaporating a fluid by converting rotary kinetic energy into heat. Configured for fluid heating, the system may comprise a rotary kinetic energy generator, a rotary heating device and a primary heat exchanger all in closed-loop fluid communication. The rotary heating device may be a water brake dynamometer. The document discloses the use of the system for heating water in offshore drilling or production platforms. However, the presented system is not suitable for heating gaseous media, neither is it feasible for use with high- and extremely high temperatures (due to liquid stability, vapor pressure, etc.).

Additionally, some rotary turbomachine-type devices are known to implement the processes of hydrocarbon (steam) cracking and aim at maximizing the yields of the target products, such as ethylene and propylene.

In this regard, an update in the field of technology related to design and manufacturing of efficient heating systems, in particular those suitable for production of hydrogen from alternative feedstocks in industrial scale at high- and extremely high temperatures is still desired, in view of addressing challenges associated with raising temperatures of fluidic substances in efficient and environmentally friendly manner.

### SUMMARY OF THE INVENTION

An objective of the present invention is to solve or to at least mitigate at least some of the problems arising from the limitations and disadvantages of the related art. One or more objectives are achieved by various embodiments of the methods for generation of a heated fluidic medium described herein, the rotary apparatuses and related uses as defined herein.

In an aspect, a method for thermal or thermochemical conversion of ammonia or methanol feedstocks into hydrogen is provided, the method comprising generation of a heated fluidic medium by at least one rotary apparatus integrated into a related feedstock conversion facility.

According to an embodiment, a method comprises generation of the heated fluidic medium by at least one rotary apparatus comprising: (a) a rotor with a plurality of rotor blades arranged into at least one row around a rotor hub mounted onto a rotor shaft; (b) a plurality of stationary blades or vanes arranged into an assembly adjacent to the at least one row of rotor blades; and (c) a casing with a duct formed between at least one inlet and at least one outlet, the duct configured to encompass rotating and stationary blades such that bladeless portion(s) of the duct is/are arranged essentially subsequently to bladed portions thereof, wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, wherein the method further comprises: supplying the stream of heated fluidic medium generated by the at least one rotary apparatus into the feedstock conversion facility, and operating said at least one rotary apparatus and said feedstock conversion facility to carry out thermal or thermochemical conversion of ammonia or methanol feedstocks into hydrogen at temperatures essentially equal to or exceeding about 500 degrees Celsius (° C.).

In an embodiment, in said method, in the feedstock conversion facility, the at least one rotary apparatus is connected to at least one feedstock conversion device configured to carry out thermal or thermochemical conversion of ammonia or methanol feedstocks into hydrogen at temperatures essentially equal to or exceeding about 500 degrees Celsius (° C.).

In an embodiment, the method comprises supplying the stream of heated fluidic medium generated by at least one rotary apparatus into at least one feedstock conversion device within the feedstock conversion facility.

In an embodiment, in said method, the feedstock conversion device comprises an at least one reactor or a furnace configured to carry out thermal and/or catalytic processes to generate hydrogen from ammonia or methanol.

In an embodiment, the method comprises generating a heated fluidic medium in the at least one rotary apparatus by virtue of adding thermal energy to the fluidic medium propagating therethrough, and using said fluidic medium as a carrier to transfer thermal energy to at least one feedstock conversion device and to heat the stream of ammonia or methanol feedstock-containing process fluid in said feedstock conversion device to the temperature(s), at which conversion reactions occur.

In an embodiment, the method comprises subjecting ammonia or methanol feedstocks to thermal or thermochemical conversion in the at least one rotary apparatus, wherein conversion reactions are initiated in a stream of ammonia or methanol feedstock-containing process fluid propagating through the rotary apparatus by virtue of adding thermal energy required for conversion reactions to occur directly to the stream of said feedstock-containing process fluid.

In embodiments, thermal or thermochemical conversion of ammonia or methanol feedstocks is carried out by pyrolysis and/or reforming, optionally, in presence of steam.

In embodiments, the method comprises comprising generation, by at least one rotary apparatus, of the fluidic medium heated to the temperature essentially equal to or exceeding about 500 degrees Celsius (° C.).

In an embodiment, the method comprises supplying the stream of heated fluidic medium generated by the at least one rotary apparatus into the feedstock conversion facility to provide external heat to at least one feedstock conversion device within said facility.

In embodiments, in said method, the heated fluidic medium generated by the at least one rotary apparatus comprises ammonia (NH₃) or methanol (CH₃OH).

In an embodiment, in said method, the fluidic medium that enters into the at least rotary apparatus is an essentially gaseous medium.

In embodiments, in said method, the heated fluidic medium generated in the at least one rotary apparatus comprises any one of air, oxygen gas (O₂), nitrogen gas (N₂), nitrogen oxide (NOx), hydrogen gas (H₂), carbon dioxide (CO₂), carbon monoxide (CO), a hydrocarbon-containing gas, or a combination thereof. In an embodiment, in said method, the heated fluidic medium generated in the at least one rotary apparatus comprises steam (H₂O).

In an embodiment, in said method, the heated fluidic medium generated by the at least one rotary apparatus comprises a recycle gas recycled from exhaust gases generated during feedstock conversion process(es) in the feedstock conversion facility.

In embodiments, in said method, the feedstock conversion device comprises at least one pyrolysis reactor and/or at least one reforming reactor, configured to operate with or without steam. In some configurations, the feedstock conversion device is adapted for pyrolysis (cracking) of ammonia. In some other configurations, the feedstock conversion device is adapted for reforming of methanol. In an embodiment, the feedstock conversion device comprises at least one packed bed reactor. In an embodiment, the feedstock conversion device comprises catalyst.

In an embodiment, the method comprises adjusting velocity and/or pressure of the stream of fluidic medium propagating through the rotary apparatus.

In an embodiment, in said method, the heated fluidic medium is generated by at least one rotary apparatus comprising two or more rows of rotor blades sequentially arranged along the rotor shaft. In an embodiment, the heated fluidic medium is generated by at least one rotary apparatus, in which the bladeless portion of the duct is arranged downstream of the at least one row of rotor blades.

In an embodiment, the method comprises connecting at least two rotary apparatuses into a system, in which a first apparatus is rendered with a preheater function to (pre) heat the ammonia or methanol feedstock-containing process fluid, and a second apparatus arranged downstream of the first apparatus is rendered with a thermal cracker function.

In an embodiment, in said method, the at least one rotary apparatus is electrically operated and wherein electrical energy constitutes 5 to 100 percent of a total energy consumption by said at least one rotary apparatus.

In embodiments, in said method, electrical energy consumed by the at least one rotary apparatus is obtainable from a source of renewable energy or a combination of different sources of energy, optionally, renewable energy.

In additional or alternative embodiments, in said method, the at least one rotary apparatus is configured to receive input energy from a non-electric power source, such as a power turbine and/or a mechanical drive engine.

In another aspect, a hydrogen production facility is provided, according to what is defined in the independent claim 27.

In an embodiment, the hydrogen production facility comprises at least one reactor or furnace configured to produce hydrogen from ammonia or methanol feedstocks at temperatures essentially equal to or exceeding about 500 degrees Celsius (° C.) and at least one rotary apparatus configured to generate a heated fluidic medium for inputting thermal energy into said at least one reactor or furnace.

In another aspect, an assembly is provided and comprises at least two rotary apparatuses according to some previous aspect, said rotary apparatuses being connected in parallel or in series.

In a further aspect, an arrangement is provided and comprises at least one rotary apparatus according to some previous aspect, said at least one rotary apparatus being connected to at least one reactor or furnace.

In a further aspect, a hydrogen production facility is provided, according to what is defined in the independent claim 29. In embodiments, the facility is configured to implement a hydrogen production process through a method according to some previously defined aspects and embodiments; and it comprises at least one rotary apparatus as defined herein.

The utility of the present invention arises from a variety of reasons depending on each particular embodiment thereof.

Overall, embodiments of the invention offer a rotary fluid heater to generate high temperature fluids, such as gases, which can be further used, instead of fuel-fired heaters for example, in a variety of heat-consuming processes related to production of hydrogen from sustainable sources The rotary heater can be electrified fully or partly. The presented method further enables inputting thermal energy into heat-consuming utilities such as reactors and/or furnaces adapted to accommodate the reactions related to hydrogen production and operating at high- and extremely high temperatures, such as temperatures generally exceeding 500° C. These reactors and/or furnaces have high demand for thermal energy and hence for heat consumption. The invention offers apparatuses and methods for heating fluidic substances to the temperatures within a range of about 500° C. to about 1200° C., i.e. the temperatures typically used in hydrogen production industry.

In the method, the advantages accompanied by replacing fired heaters with the rotary apparatus include at least:
Support for electrified heating;
Elimination or at least significant reduction of greenhouse gas (-es), such as NO, CO₂, CO, NO_{X}, originating from fuels, particle emissions and soot emissions;
Reduced volume of a heater: the volume of the rotary apparatus is at least one order of magnitude smaller as compared to the volume of conventional process heaters or heat exchangers;
Decreased investment costs;
Feasibility in handling large volumes of gases;
Absence of pressure drop;
Possibility of using the rotary (heater) apparatus also for compression of gases (a blower function);
Independency on temperature difference in direct heating of gases. Temperature rise in the rotary apparatus can be in range of about 10 to 1200° C. and even higher;
Possibility for using the rotary apparatus in indirect heating of fluids optionally by optimizing temperature difference in heat exchanger(s);
Possibility for at least partial recycling of hot process gases and/or flue gases, thus improving and making simpler the heat recovery and improving energy efficiency;

By replacing conventional fired heaters or process furnaces for direct or indirect heating with rotary apparatus (-es) in process applications related to hydrogen production, significant reduction or elimination of greenhouse gas-(CO, CO₂, NOₓ) and particle emissions can be achieved. This can be achieved with making the rotary apparatus electrically driven and/or through process gas/flue gas recycling loops. By using the rotary apparatus, closed or semi-closed heating loops for hydrogen production processes can be enabled, which can further improve energy efficiency of these processes by reducing heat losses through recycling flue gases. On the contrary, in conventional heaters, flue gases can be recycled only partly.

For example, in methanol steam reforming, by providing the (electrified) rotary fluid heater apparatus in place of a conventional furnace, formation of flue gases and hence formation of the dilute CO₂ source (typically resulting from fuel burning) can be avoided. Combined with already available techniques for carbon capture from reforming and decomposition reactions, the method disclosed hereby enables achieving a CO₂ emission-free hydrogen production.

Integration of the rotary apparatus into pyrolysis of ammonia or methanol feedstocks solves or at least alleviates problems related to formation of carbon deposits on hot heating surfaces in furnaces or other type of heaters due to long residence times. Residence time of feedstock gas (-es) in the rotary apparatus can be minimized such that an extent of carbon formation will be significantly decreased. Additionally or alternatively, the temperature of said feedstock gas propagating through the rotary apparatus can be increased by arranging rotor unit(s) within the apparatus such that conversion rate of the reactions is improved and carbon deposits do not interfere with the rotating parts of the machine. The rotary apparatus can thus be used in pyrolytic decomposition of ammonia or methanol feedstocks into hydrogen in connection with different type of pyrolysis reactors with or without catalysts to reach sufficient conversion of feedstocks.

The rotary apparatus can be used for direct heating of process gases, inert gases, air or any other gases or for indirect heating of process fluids (liquid, vapor, gas, vapor/liquid mixtures etc.). For example, the rotary apparatus can be used for direct heating of a recycle gas recycled from exhaust gases generated during the hydrogen production process.

Heated fluid generated in said rotary apparatus can be further used for heating any one of gases, vapor, liquid, and solid materials. Hence, hot gases generated in the rotary apparatus can be used for heating solid materials or they can be used for heating the feed in a packed reactor adapted for any one of catalytic and thermal processes. The method offered herewith further allows for using hot gases as heating media in heat exchangers in order to indirectly heat process gases or liquids. Additional uses, such as in an evaporator, are not excluded.

The rotary apparatus can at least partly replace- or it can be combined with (e.g. as preheater) multiple types of furnaces, heaters and reactors that are traditionally fired or heated with solid, liquid or gaseous fossil fuels or in some cases bio-based fuels, including reactors and furnaces used in hydrogen production. Heated gases can be recycled back to the rotary apparatus. In addition to its heating function, the rotary apparatus may also act as a blower (combined heater blower functionality), thus allowing to increase pressure and to recycle gas in various applications, such as for example in catalytic fluidized bed reactors.

Additionally, the present solution enables improved optimization of the temperature difference(s) in the heat exchangers in indirect heating.

The invention further provides for flexibly using electrical energy, such as electrical energy obtainable from renewable sources. Production of renewable energy varies on daily basis and even on hourly basis. The invention allows for balancing renewable electricity production by integration of the rotary apparatus disclosed herewith with conventional fuel-operated (fuel-fired) heaters to provide heat to a variety of processes involved in hydrogen production.

The invention further enables a reduction in the on-site investment costs as compared to traditional fossil fired furnaces.

The expression “a number of” refers hereby to any positive integer starting from one (1), e.g. to one, two, or three. The expression “a plurality of” refers hereby to any positive integer starting from two (2), e.g. to two, three, or four. The terms “first” and “second”, are used hereby to merely distinguish an element from another element without indicating any particular order or importance, unless explicitly stated otherwise.

Different embodiments of the present invention will become apparent by consideration of the detailed description and accompanying drawings.

### BRIEF DESCRIPTION OF THE DRAWINGS

FIGS. 1A and 2 are block diagrams representing, at 1000, 1000A, 1000B, layouts for a facility and method for hydrogen production from ammonia feedstocks, according to the embodiments.

FIG. 1B schematically illustrates a feedstock conversion unit 101 for catalytic and non-catalytic conversion of ammonia to hydrogen within related facility 1000.

FIGS. 3A-3C and 4 are block diagrams representing, at 2000, 2000A-2000D, layouts for a facility and method for hydrogen production from methanol feedstocks, according to the embodiments.

FIG. 5 illustrates a concept of indirect heating approach using a rotary apparatus 100 to replace fuel-fired burner(s) in a furnace.

### DETAILED DESCRIPTION OF THE EMBODIMENTS

Herein disclosed is a method for thermal or thermochemical conversion of ammonia or methanol feedstocks into hydrogen (gas) in a related feedstock conversion facility, hereafter, “conversion facility”. Conversion facility may be configured to implement the processes of ammonia conversion to hydrogen, the processes of methanol conversion to hydrogen, or both. Additionally, devices and systems configured to implement thermal or thermochemical conversion within the conversion facility are disclosed.

The feedstock conversion facility 1000, 2000 is thus configured to carry out heat-consuming industrial process or processes aiming at production of hydrogen from feedstocks comprising or consisting of ammonia or methanol at temperatures essentially equal to- or exceeding 500 degrees Celsius (° C.). In embodiments, the facility 1000, 2000 is configured to carry out thermal or thermochemical conversion process(es) at temperatures within a range of 500-1700° C., preferably, 500-1200° C., and at any temperature value falling in between these temperature points. In embodiments, the facility 1000, 2000 is configured to carry out the heat-consuming industrial process(es) which start at temperatures essentially within a range of about of 600-850° C. or higher. In embodiments, the facility 1000, 2000 is configured to carry out the heat-consuming industrial process(es) at temperatures essentially equal to- or exceeding 850° C. Overall, the facility can be configured to carry out industrial process(es) at temperatures equal to or above 1000° C., such as up to 1200° C. and beyond. It should be pointed out that the facility 1000, 2000 is not excluded from carrying out of at least a part of industrial processes at temperatures below 500° C.

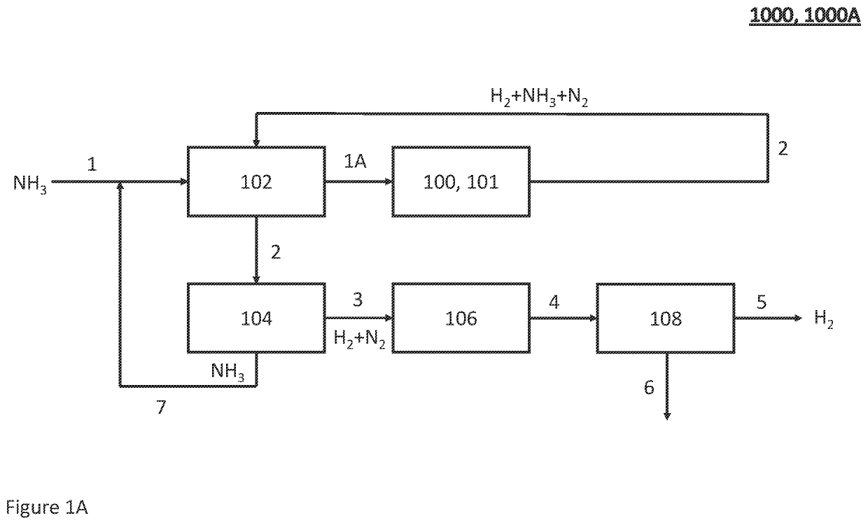

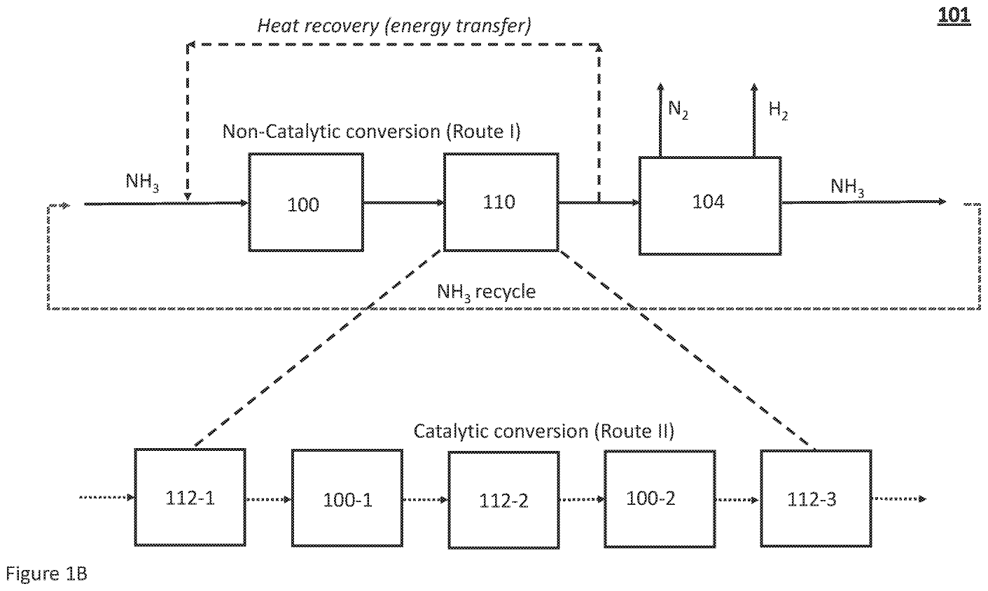

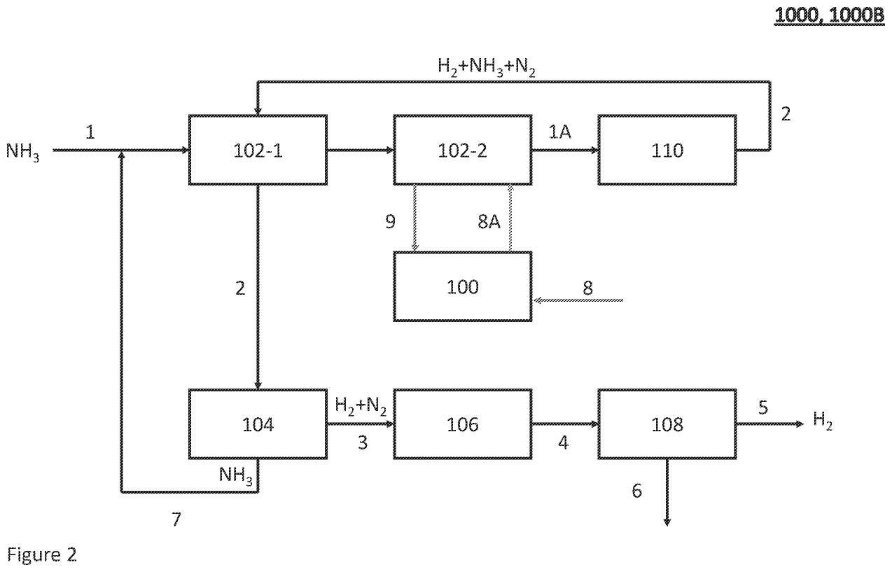

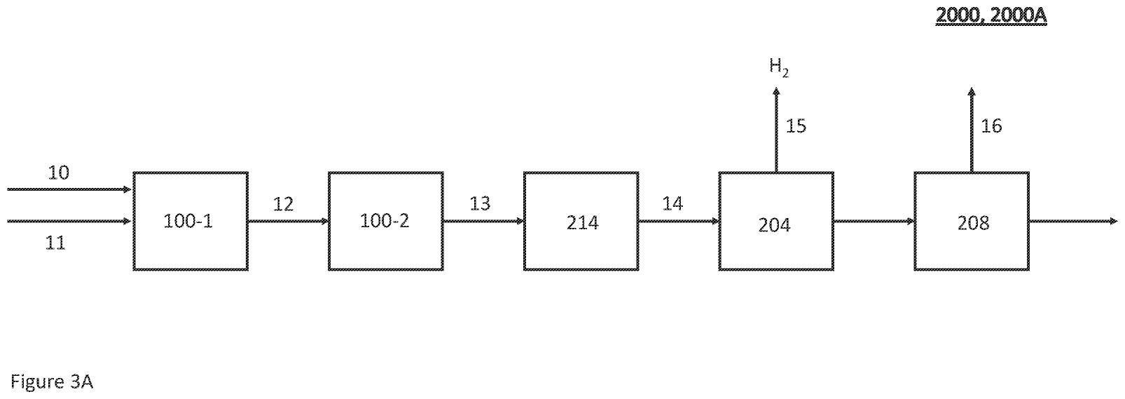

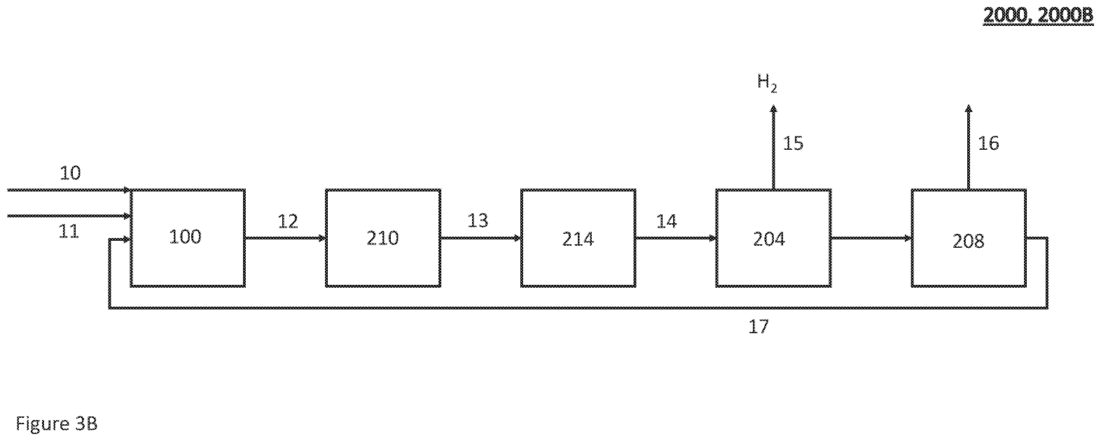

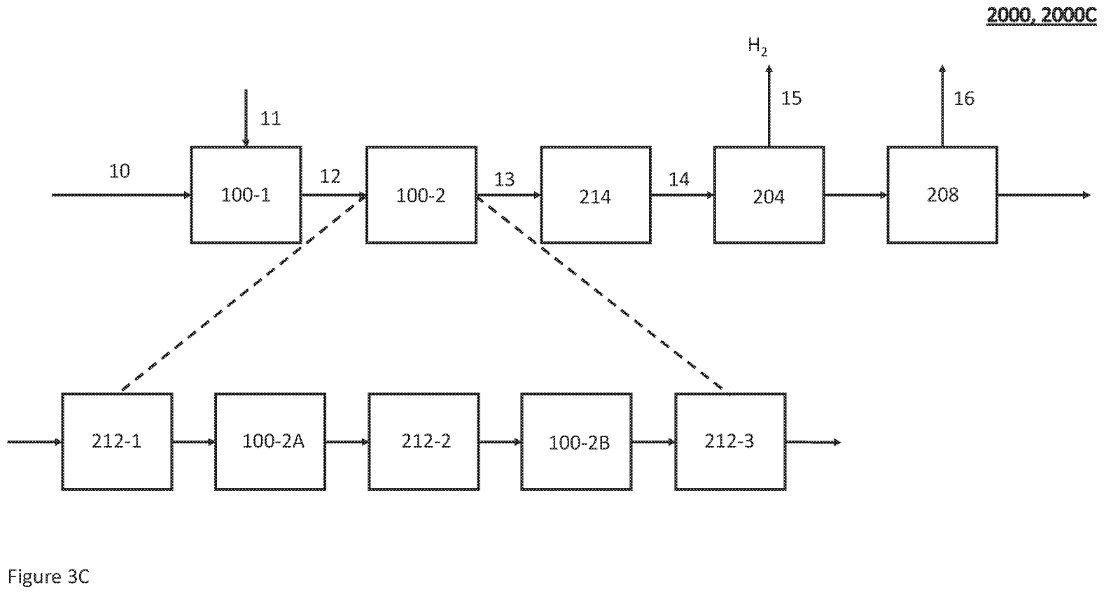

The disclosed method comprises heating a stream of fluidic medium by at least one rotary apparatus (described further below); supplying the stream of heated fluidic medium to the conversion facility; and operating the at least one rotary apparatus and the conversion facility to carry out thermal or thermochemical conversion of ammonia or methanol into hydrogen at temperatures essentially equal to or exceeding about 500 degrees Celsius (° C.). A stream of fluidic medium heated by the rotary apparatus may include a feedstock containing fluid (gas or liquid), a dilution gas, a process gas/working gas (e.g. a mixture of feedstock containing fluid with dilution gas), a make-up gas (a so-called replacement/supplement gas), a recycle gas, and the like. With regard to feedstocks, hereby, any one of ammonia and methanol, the rotary apparatus can be set up to provide direct heating (FIGS. 1A, 1B, 3A-3C) or indirect heating (FIGS. 2, 4, 5). The term “direct heating” is used, in the present disclosure, where the fluidic medium to be heated in the rotary apparatus comprises a feedstock compound (ammonia or methanol) preferably in gaseous/vaporized from. In such an event, the rotary apparatus is used for direct heating of feedstock-containing stream(s). In indirect heating, the fluidic medium heated in the rotary apparatus does not contain feedstock (and it is not in direct contact with the feedstock) and serves as a heat transfer medium/heat carrier medium to transfer heat to the feedstock-containing process fluid in a contactless (indirect) manner.

In embodiments, thermal or thermochemical conversion processes include pyrolysis (also referred to as “cracking”), reforming, or both. In present disclosure, the terms “pyrolysis” and “cracking” are used interchangeably. When carried out in presence of steam (H₂O), pyrolysis is referred to, in the present disclosure, as steam cracking. Any one of cracking and reforming can be implemented as thermal or catalytic process (-es).

In some configurations, the feedstock conversion device is adapted for pyrolysis (cracking) of ammonia. In some other configurations, the feedstock conversion device is adapted for reforming of methanol. In present disclosure, the term “reforming” relates to steam reforming, unless explicitly indicated otherwise. When referred to thermal/thermochemical decomposition of methanol, the terms “steam cracking” and “steam reforming” (or simply “reforming”) are used interchangeably.

FIGS. 1-4 schematically illustrate exemplary layouts for a feedstock conversion facility 1000, 2000 configured to implement the method according to the embodiments. Figures and related examples serve illustrative purposes and are not intended to limit applicability of the inventive concept to the layouts expressly presented in this disclosure. Block diagram sections shown by dotted lines are optional.

FIG. 1A thus shows, at 1000, 1000A a facility layout configured for conversion of ammonia to hydrogen via a process of thermal cracking or catalytic cracking. In the layout of FIG. 1A a feed stream 1 directed into a rotary apparatus 100 comprises or consists of ammonia (NH₃) feedstock.

Overall, it is preferred that feed 1 enters the apparatus 100 in essentially gaseous form. Preheating of feed or conversion of liquid or essentially liquid feed(s) into gaseous form can be performed in a preheater unit 102 configured as a (pre) heater apparatus or a group of apparatuses. In the preheater 102, feed stream(s) originally provided in gaseous form (e.g. ammonia gas) can be further heated. If not already in gas form, in said preheater 102 feed stream can be vaporized and optionally (super) heated.

In the layout of FIG. 1A, feed 1 enters the apparatus 100 via a preheater unit provided in a heat exchanger configuration (102). In the heat exchanger/preheater 102, said feed 1 may be preheated against hot product gas (-es) generated during high-temperature conversion reaction (-s) (stream 2). Preheated feed 1A flows into the rotary apparatus 100. The apparatus 100 can be provided as a standalone unit or it can be provided within a feedstock conversion unit 101 schematically shown on FIG. 1B. In the facility layout 1000, 1000A, conversion of ammonia to hydrogen can be carried out directly in the apparatus 100 or within the conversion unit 101. It is noted that the layout of FIG. 1A may comprise the rotary apparatus 100 alone or the same provided as a part of the feedstock conversion unit 101 shown on FIG. 1B. Further, provision of several rotary apparatuses 100 connected in sequence is not excluded.

When carried out in the apparatus 100, conversion reactions are initiated in a stream of ammonia feedstock-containing process fluid propagating through the rotary apparatus by virtue of adding thermal energy required for conversion reactions to occur directly to the stream of said feedstock-containing process fluid. Mechanism of imparting thermal energy into fluidic stream propagating through the rotary apparatus 100 is explained further below.

In the apparatus 100/conversion unit 101, ammonia feed 1 is thermally decomposed to yield a hydrogen-containing gaseous product (stream 2). Typically, product stream 2 is a mixture of hydrogen (H₂), nitrogen (N₂) and unreacted ammonia. Product stream 2 is further directed, via the heat exchanger 102, to post-processing including purification and/or heat recovery. In exemplary layout of FIG. 1A, unreacted ammonia is separated from the product stream 2 in a purification unit 104 (NH₃ removal). Recovered ammonia can be recycled (stream 7) and combined with feed 1. Depending on a separation process, recycle stream 7 may further contain trace amounts of nitrogen and hydrogen.

A mixture of nitrogen (gas) and hydrogen (gas) continues, at stream 3, to a compression unit 106, from where a compressed gas 4 (H₂+N₂ mix) is directed to a separation unit 108. In the unit 108, nitrogen is separated from the gas mixture and a hydrogen (gas) product (H₂) is recovered at stream 5. Side stream 6 containing nitrogen gas (N₂) is withdrawn.

Purification, compression and separation devices (104, 106 and 108, respectively) may be combined within a common post-processing unit (not shown).

FIG. 1B illustrates provision of a feedstock conversion unit 101 within the facility 1000, 1000A. In said feedstock conversion unit 101, ammonia feed 1, 1A can be subjected to thermal or thermochemical conversion/decomposition to yield hydrogen product. In the feedstock conversion unit 101, at least one rotary apparatus 100 is connected to at least one feedstock conversion device 110 configured to carry out thermal or thermochemical conversion of ammonia feedstocks into hydrogen at temperatures essentially equal to or exceeding about 500 degrees Celsius (° C.). Thermochemical conversion may be implemented, within said feedstock conversion device, with or without catalyst. Connection between the rotary apparatus 100 and the feedstock conversion device 110 within the conversion unit 101 may be direct or indirect, such as via a heat exchanger (not shown).

In embodiments, the feedstock conversion device 110 comprises or consists of at least one reactor or furnace configured to carry out thermal and/or catalytic processes to generate hydrogen from ammonia.

FIG. 1B illustrates exemplary layouts for ammonia conversion to hydrogen via thermal (non-catalytic) conversion (Route I) and via catalytic conversion (Route II).

In non-catalytic conversion, feed (hereby, ammonia/stream NH₃) undergoes (pre) heating in the rotary apparatus 100, where from (pre) heated feed continues to a conversion reactor 110. Heating of ammonia stream in the apparatus 100 should be very fast (within a few milliseconds), in order to avoid ammonia decomposition before the feed streams reaches at least a lastmost rotor unit (of the apparatus 100). Conversion reactor 110 may be configured as an adiabatic reactor of any appropriate design, where conversion/decomposition processes proceed in an absence of heat transfer in- or out of the system, which is typically achieved by appropriate insulation or by carrying out the reactions very rapidly.

Resulting product mixture (NH₃+N₂+H₂) undergoes post-processing in a combined purification/separation unit 104. Unreacted ammonia can be recycled back to the feed stream (NH₃ recycle).

FIG. 1B also shows a route for thermal energy (heat) recovery. Heat is recovered through energy transfer, and it may be implemented via any appropriate method, such as in heat exchanger(s), for example (not shown).

In embodiments, the feedstock conversion device 110 comprises catalyst. In such an event, decomposition of ammonia feedstock to hydrogen follows a catalytic conversion route (Route II, FIG. 1B). In embodiments, the catalyst is provided in the form of catalytic surface(s) and/or catalytic element(s). Catalytic surfaces may be formed with catalytic coating(s) on at least a part of internal walls/lining within the conversion reactor 110. Catalytic elements may be formed by or provided with large-surface-area substrates or support carriers (e.g. porous metallic or ceramic substrates) with an active coating. Monolithic honeycomb catalysts may also be utilized. In some other embodiments, the feedstock conversion device comprises or consists of at least one catalytic packed bed reactor. In embodiments, the reactor(s) 110 is/are then configured as fluidized bed reactor (FBR) device(s). FBR device(s) may follow any conventional gas-solid equipment design adapted to carry out mass and/or heat transfer processes between gaseous fluids and a bed of substantially solid material. In different configurations, the FBR reactor(s) may be provided as any one of a stationary (fixed) fluidized bed reactor, a bubbling fluidized bed reactor, a circulating fluidized bed reactor, an entrained fluidized bed reactor, or a counter-current fluidized bed reactor. The latter may be provided with a downwards solid flow towards the gas flow.

In additional or alternative embodiments, at least one rotary apparatus 100 is configured to comprise a catalyst. In some instances, the rotary apparatus 100 may be rendered with a conversion reactor function and hence provision of a separate feedstock conversion reactor 110 may be omitted (see configuration described with regard to FIG. 3A). Catalyst may be provided, within the rotary apparatus 100, as a catalytic coating on at least some rotor blades and/or stationary elements, such as stationary blades for example, and/or on at least a part of interior wall defining a reaction space within the rotary apparatus. Additionally or alternatively, the rotary apparatus may comprise catalytic elements as described hereinabove.

Since catalytic reactions are typically carried out at temperature ranges where the used catalyst is the most active, the reaction may be carried out in several steps and the setup 101 may include more than one catalytic reactor 112-1, 112-2, 112-3. Configurations with or without catalyst beds may be conceived. Large-surface-area catalyst beds may be beneficial in reactions involving desorption of nitrogen from the catalytic surfaces (e.g. involved in thermochemical conversion of ammonia to hydrogen). Rotary apparatuses 100-1, 100-2 may be arranged between the catalytic reactors 112-1, 112-2, 112-3 to provide thermal energy for catalytic conversion reactions by feed/process fluids and introducing hot feed/process fluid with ascending temperature profile to catalytic beds. To maintain reaction rate and to bring the reactions into completion, the rotary apparatus can thus serve as a reheater between catalytic reactors.

It is noted that in all layouts 1000, 2000 described herein above and involving the use of fluidized bed reactor technology, the rotary apparatus 100 can be designed to increase pressure of the fluidic stream. Hence the rotary apparatus can be rendered with an additional blower function—to add velocity to heated fluidic medium supplied into the feedstock conversion unit(s). In this way, heated fluidic medium also serves as a fluidization agent and efficiently fluidizes the bed material in related reactor devices. The apparatus 100 adapted to act as blower provides necessary pressure increase for the fluid to circulate through the solid bed material provided within the feedstock conversion unit. The apparatus 100 may thus replace a separate air blower/system fan.

The feedstock conversion unit 101 can be further adapted for the processes of conversion of methanol feedstocks to yield hydrogen.

Reference is made to FIG. 2 showing, at 1000, 1000B, a concept of a so-called indirect heating in a process of ammonia conversion/decomposition to hydrogen, where the rotary apparatus 100 replaces a conventional fired burner. In the layout of FIG. 2, the rotary apparatus 100 is configured to heat a fluidic stream 8 to generate a stream of heated fluid 8A, which can be further used as a carrier to transfer thermal energy to at least one feedstock conversion device 110 configured to implement/mediate conversion of feed (e.g. ammonia feed 1) to hydrogen.

For example, an inert gas, such as air, nitrogen, carbon oxides (CO, CO₂) or steam (H₂O) can be heated in the rotary apparatus 100 and further used, as stream 8A, to convey the heat generated by the rotary apparatus to a reactor or furnace 110 adapted to perform a hydrogen production process and to heat the stream of process fluid (hereby, NH₃) in said reactor or furnace 110 to the temperature(s), at which thermal or thermochemical conversion/decomposition of ammonia to hydrogen occurs. Fluid 8A heated in the rotary apparatus 100 may be directed to the reactor or furnace 110 directly (not shown), or via a heat exchanger 102 (unit 102-2). Fluidic stream 8A serves as a heat transfer medium, which indirectly heats the feed stream 1, 1A flowing to the reactor 110 (i.e. fluids 1A and 8A do not mix). After having transferred its heat to the stream 1A, the heat transfer fluid 8A is recycled, as a “cold” stream 9, back to the rotary apparatus 100 for re-heating. Stream 1A (NH₃) heated in indirect manner proceeds to the conversion device 110 (reactor or furnace), and the process continues similarly to that shown on FIG. 1A. Reference numerals 1-7 of FIG. 2 correspond to that of FIG. 1A. It is noted that the layout of FIG. 2 comprises more than one heat exchanger device 102, wherein a first heat exchanger device 102-1 serves as a feed preheater and cools the product 2 before purification, while the second heat exchanger 102-2 is arranged between the rotary apparatus 100 and the reactor 101. In some instances, provision of the second heat exchanger 102-2 may be omitted and the heat transfer fluid 8A can be conveyed to the reactor/furnace 110 (not shown).

The heated fluidic medium used as a thermal energy carrier can be any species, such as for example air, nitrogen gas, steam, flue gas (-es) exhausted from the reactor/furnace 110, and any combination thereof.

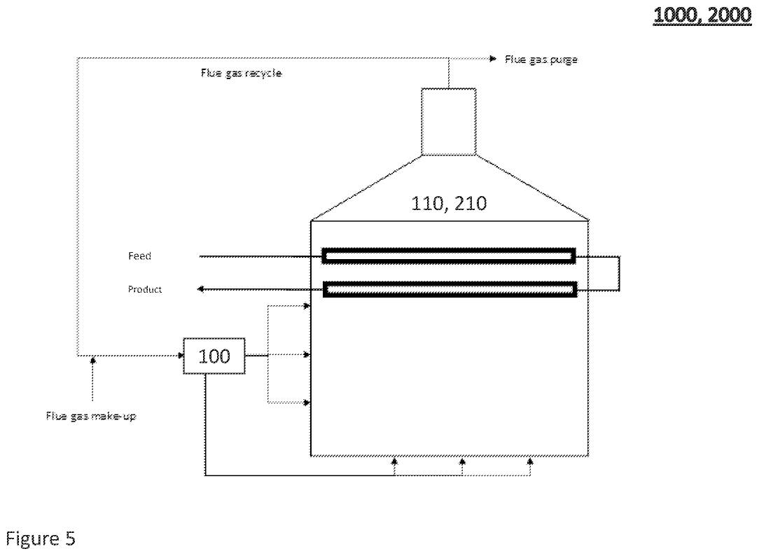

Facility 1000, 2000 for hydrogen production from ammonia or methanol, respectively, where rotary apparatus 100 is arranged to replace fuel-fired burners and to provide thermal energy for heating the feed stream in indirect manner, is illustrated on FIG. 5.

FIGS. 3A-3C illustrate a so called direct process concept of methanol steam reforming. In some configurations, a mixture of methanol and steam may be directed to the to the rotary apparatus, where conversion reaction(s) may be allowed to occur (not shown). FIG. 3A illustrates a facility layout 2000, 2000A where a feed stream 10, hereby methanol, and/or a dilution stream 11, hereby (water) steam is/are directed to a first rotary apparatus 100-1 adapted to act as a preheater. Streams 10, 11 may enter the rotary apparatus 100-1 as separate streams or as a combined stream/a mixture. Preheated mixture 12 flows to the second rotary apparatus 100-2, where conversion/decomposition reaction(s) take place. Alternatively, a number of preheating stages may be provided in the same rotary apparatus, as explained further below.

A separate Water-Gas Shift (WGS) reactor 214 can be used to receive an outflow 13 from the rotary apparatus 100-2 rendered with a conversion reaction function, and to convert carbon monoxide produced by methanol decomposition reaction(s) into carbon dioxide thus increasing hydrogen yields. Stream 13 contains products formed during steam reforming in the apparatus 100-2. WGS reactor outflow 14 is further directed to a hydrogen separation unit 204, in where hydrogen product 15 is obtained. Carbon dioxide separation unit 208 can be provided to purify exhaust gas (-es)/flue gas (-es) discharged from the feedstock conversion reactor(s)/furnace(s), e.g. carbon dioxide, for further carbon capture (not shown). Carbon dioxide is thus removed, at stream 16, and optionally sent for carbon capture. Suitable methods for separation/purification of gases include for example filtration, such as hot filtration, distillation, absorption, e.g. Pressure Swing Adsorption (PSA), cryogenic processes, and any combination of these methods.

FIG. 3B shows, at 2000, 2000B, an alternative configuration, where the feed mixture of methanol 10 and steam 11 is (pre) heated while flowing through the apparatus 100 and so (pre) heated feed 12 is directed to a feedstock conversion device 210 where conversion reaction(s) is/are allowed to proceed. In the layout of FIG. 3B, the feedstock conversion device 210 can be configured as an adiabatic reactor. In the adiabatic reactor, sufficient residence time is allowed for the reactions to proceed to near the equilibrium. Product mixture 13 exiting the conversion reactor 210 proceeds to fractionation/refining section, which may comprise WGS 214, hydrogen separation unit 204, carbon dioxide separation unit 208, etc. Reference numbers 14, 15 and 16 are the same as for FIG. 3A. Hydrogen product stream 15 is obtained in the hydrogen separation unit 204. If conversion rate achieved in the reactor 210 is not sufficiently high, methanol (and water) can be recycled, at stream 17, back to the feed stream (10, 11) entering the rotary apparatus 100 after the hydrogen product 15 and carbon dioxide 16 have been separated therefrom. Recycle stream 17 can be combined with the feed mixture before the apparatus 100 or it can be fed directly into the apparatus 100. Prior to entering the apparatus 100, the recycle stream 17 can undergo purification via filtering, for example (not shown).

FIG. 3C shows a catalytic reaction concept for methanol conversion similar to that shown for ammonia conversion on FIG. 1B (rf. Catalytic conversion, Route II). Catalytic conversion facility 2000, 2000C can be set up with a number of catalytic reactors 212 as shown on FIG. 3C. The layout of FIG. 3C may comprise a first rotary apparatus 100-1 configured as a (pre) heater and a second rotary apparatus 100-2 rendered, in some embodiments, with a conversion reactor function. In such as event, conversion of methanol feedstocks occurs in the rotary apparatus 100-2 and the product outflow 13 may proceed to WGS reactor 214 and further—to hydrogen product separation section 204, as described with regard to FIGS. 3A and 3B.

In embodiments, the rotary apparatus 100-2 rendered with a conversion function may be replaced with or provided as a part of an arrangement including at least one rotary apparatus 100 and a conversion reactor 212. In some configurations, the conversion reactor 212 is provided as a catalyst bed reactor. In some instances, more than one catalyst bed reactor may be provided (FIG. 3C show an arrangement with three catalytic reactors 212-1, 212-2, 212-3). Rotary apparatuses 100-2A, 100-2B may be arranged between the reactors 212-1, 212-2, 212-3 to provide additional heating of the process fluid. Whether the rotary apparatuses 100-2A, 100-2B are arranged to alternate with catalytic reactors 212-1, 212-2, 212-3, they may be rendered to heat the process fluid while catalytic reactors implement a conversion function.

In embodiments, the rotary apparatus 100-2 may be replaced with any kind of conversion reactor comprising catalyst. In some embodiments, the conversion reactor may be an adiabatic reactor (not shown). In some other embodiments, preheating and conversion functions may be combined in the same rotary apparatus. In such an event, the rotary apparatus is rendered with the conversion reactor function, and it may comprise a catalyst, as described hereinabove.

In some other embodiments, the rotary apparatus 100-2 may be replaced with- or provided as a part of a feedstock conversion unit corresponding to the feedstock conversion unit 101 shown on FIG. 1B, but adapted for processing of methanol feedstocks to yield hydrogen.

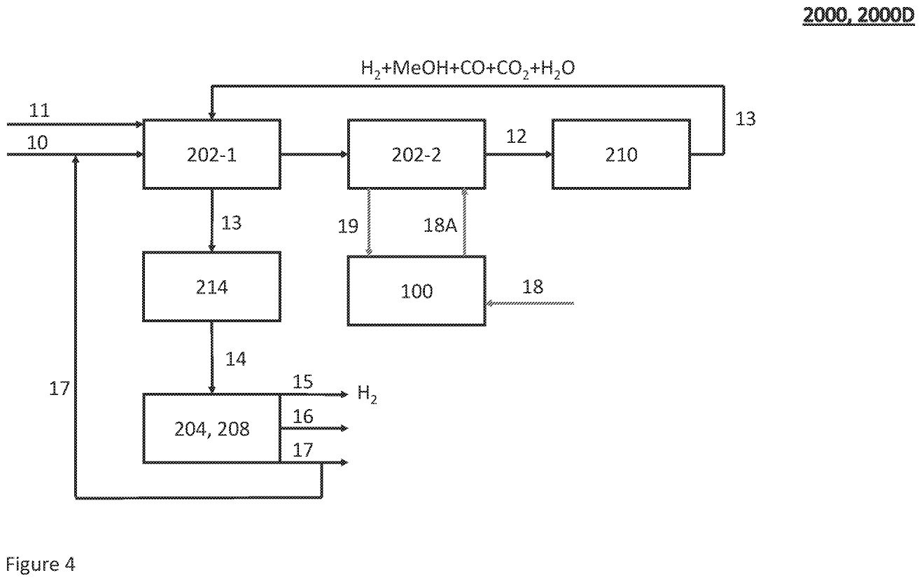

Reference is made to FIG. 4 showing a concept of a so-called indirect heating, where the rotary apparatus 100 replaces a conventional fired burner in the processes of methanol steam reforming. Overall, facility layout 2000, 2000D of FIG. 4 generally follows facility layout 1000, 1000B for ammonia conversion to hydrogen shown on FIG. 2. In the layout of FIG. 4 (2000, 2000D), at least one rotary apparatus 100 is configured to heat a stream 18 to generate a stream of heated fluid 18A, which can be further used as a carrier to transfer thermal energy to at least one feedstock conversion device 210 configured to implement/mediate conversion of feed, hereby, a mixture of methanol 10 and steam 11, to hydrogen.

For example, an inert gas such as air, nitrogen or steam (H₂O) can be heated in the rotary apparatus 100 and further used, as stream 18A, to convey the heat generated by the rotary apparatus to a reactor or furnace 210 adapted to perform a hydrogen production process and to heat the stream of process fluid (hereby, NH₃) in said reactor or furnace 210 to the temperature(s), at which thermal or thermochemical conversion/decomposition of methanol to hydrogen occurs. Fluid 18A heated in the rotary apparatus 100 may be directed to the reactor or furnace 210 directly (not shown), or via a heat exchanger 202 (unit 202-2). Heat transfer fluid 18A heats the process fluid 12 (a mixture of methanol 10 and steam 11) flowing to the reactor 210 and is recycled, at “cold” stream 19 back to the rotary apparatus 100 for re-heating. Addition of make-up heat transfer fluid and withdrawal of heat transfer fluid for disposal is not shown. Similarly to that of FIG. 2, the layout of FIG. 4 comprises more than one heat exchanger device 202, wherein first heat exchanger 202-1 serves as a feed preheater and cools a product stream 13 before purification; while the second heat exchanger 202-2 is arranged between the rotary apparatus 100 and the reactor 210.

Product stream 13 exiting the reactor 210 is typically a mixture of hydrogen (H₂), unreacted methanol, carbon oxides (CO, CO₂) and steam (H₂O). Product stream 13 proceeds, through the heat exchanger 202-1, to WGS 214 and further, as stream 14, to purification/separation section 204, 208, where hydrogen product 15 is separated from carbon oxides and unreacted methanol Removed carbon dioxide can be further directed, as stream 16, to carbon capture, while unreacted methanol can be recycled, as stream 17, back to the feed stream. Depending on a separation process, recycle stream 17 may further contain, in addition to methanol, some hydrogen and water (steam).

The feedstock conversion device 210, such as a reactor or a furnace, may be included, along with at least one rotary apparatus 100, into the feedstock conversion unit, such as 110 shown on FIG. 1B, but adapted for production of hydrogen from methanol feedstocks (not shown).

FIG. 5 illustrates, at 1000, 2000, a facility configured to implement a method for conversion of ammonia or methanol feedstocks according to the embodiments. Configuration of FIG. 5 involves using the rotary apparatus 100 in indirect heating of ammonia or methanol-containing feedstocks. In the method, the processes of cracking of ammonia or (steam) reforming of methanol may be implemented in any conventional feedstock conversion device 110, 210, such as a furnace or a reactor, suitable for that purpose. By way of example, the furnace 110, 210 shown on FIG. 5 may be provided as any type of conventional ammonia cracker or a methanol steam reformer. Additionally or alternatively, the feedstock conversion device 110, 210 can be provided as a heat exchanger device, such as for example a tube bundle lined with catalyst or a plate-type heat exchanger.

Conventional pyrolysis furnace typically includes tubular coils made of metal alloys and placed in a firebox (radiant section) of the furnace. In some instances, a catalyst is placed inside the tubes. The furnace is typically lined with refractory materials. Feedstock-containing stream passes through radiant coil tubes, where thermal and/or catalytic conversion/decomposition reactions occur. In conventional furnaces, heat required for the endothermic set of pyrolysis reactions is supplied by combustion of fuel in firebox burners. In most cases, the burner(s) is/are fueled with natural gas.

According to the present disclosure, at least one rotary apparatus 100 can be retrofitted to the existing furnace 110, 210 to replace fossil fuel-fired burners. The amount of thermal energy required to heat the stream of the ammonia- or methanol feedstock-containing process fluid to temperature(s), at which conversion/decomposition reactions occur, is produced and transferred to said feedstock-containing process fluid using the rotary apparatus 100, in which a heated fluidic medium is generated by virtue of adding the amount of thermal energy to the fluidic medium propagating therethrough. The heated fluidic medium produced in the apparatus 100 may be inert gas, such as for example, air, nitrogen gas or (water) steam, or any other (gaseous) substance suitable for the purposes of the invention. Heated fluidic medium is further used as a carrier to transfer thermal energy to the conversion furnace 110, 210 and to heat the stream of feedstock-containing process fluid, flowing through said furnace, to the temperature(s), at which conversion reactions occur.

By using the apparatus (-es) 100 for indirect heating of feedstock-containing process fluids, performance of a conventional cracking furnace can be improved. As mentioned above, conventional furnaces operate by burning fossil-based fuels, such as natural gas, inside a furnace firebox, whereupon the flame and hot off-gases heat reactor coils, inside which the reactants to conversion reactions are flowing. After delivering a part of their heat to the reactants, these off-gases are vented to the atmosphere.

By replacing fuel-fired burners with the rotary apparatus (-es) 100, as shown on FIG. 5, an amount of greenhouse gas emissions can be markedly reduced or, in some instances, completely eliminated. For example, when the rotary apparatus 100 uses recycle gases shown at stream 7 (FIG. 2) and stream 17 (FIGS. 3B and 4) and/or any hot off-gases generated in the conversion process as a heating medium, no carbon dioxide emissions is generated, since no incineration takes place. Flue gases generated during the cracking process in the furnace 110, 210 (FIG. 5) can be at least partly recycled to be used as a heating medium in the apparatus 100 (optionally mixed with inert gas, for example) within the facility 1000, 2000. The amount of heat losses in flue gases discharged into the atmosphere can thus be markedly reduced.

Using the apparatus 100 as a heater in conjunction with conventional furnaces adapted for ammonia cracking or for the processes of methanol reforming/decomposition allows for reducing emissions and improving energy efficiency of said furnaces. Installation of the apparatus 100 into existing hydrogen production facilities utilizing any one of ammonia or methanol as feedstocks can be realized with very low capital requirements, since a majority of process equipment does not need to be replaced. The existing furnaces 110, 210 can be equipped with suitable piping arrangements around the reactor tube coils for example, to enable heat transfer from the fluid (e.g. inert gas) heated in the apparatus 100 to the feedstock-containing process fluid flowing through the reactor coils.

In embodiments, the method comprises generation of a heated fluidic medium by virtue of a rotary heater unit comprising or consisting of at least one rotary apparatus 100. The rotary heater apparatus 100 is preferably integrated into the feedstock conversion facility 1000 (1000A, 1000B), 2000 (2000A-2000D). In an embodiment, the heated fluidic medium is produced by the at least one rotary apparatus; however, a plurality of rotary apparatuses may be used in series (in sequence) or in parallel.

The rotary apparatus 100 can be provided as a standalone apparatus or as a number of apparatuses arranged in series or in parallel. One or more apparatuses may be connected to a common feedstock conversion unit 101 comprising at least one feedstock conversion device (conversion reactor) 110, 112 (112-1, 112-2, 112-3) 210, 212 (212-1, 212-2, 212-3).

In some configurations, a number of rotary apparatuses can be connected to several process utilities, such as reactors or furnaces (not shown). Different configurations may be conceived, such as n+x rotary apparatuses connected to n utilities (e.g. reactors), wherein n is equal to or more than zero (0) and x is equal to or more than one (1). Thus, in some configurations, the facility 1000, 2000 and, in particular, the rotary heater unit 100, may comprise one, two, three or four parallel rotary apparatus units connected to a common feedstock conversion device, for example; the number of rotary apparatuses exceeding four (4) is not excluded. When connecting, in parallel, a number of rotary apparatuses to the common feedstock conversion device, e.g. a reactor, one or more of said apparatuses 100 may have different type of drive engine, e.g. the electric motor driven reactor(s) can be combined with those driven by steam turbine, gas turbine and/or gas engine.

The rotary apparatus 100 is configured to receive a feed stream supplied from an appropriate source (see for examples streams 1, 8 on FIGS. 1A and 2 and streams 10, 11, 18 on FIGS. 3A-3C and 4). Feed stream supplied into the apparatus 100 can comprise or consist of any fluid, such as liquid or gas or a combination thereof, provided as a pure component or a mixture of components.

In embodiments, fluidic medium entering the rotary apparatus 100 and/or heated therein comprises a feedstock-containing fluid, hereby, ammonia (NH₃) or methanol (CH₃OH). Ammonia or methanol may be combined with steam (H₂O), or steam may be directed into the apparatus 100 as the only fluidic medium to be heated. In embodiments, fluidic medium entering the apparatus 100 and/or heated therein comprises an oxidative gas, such as air or oxygen gas (O₂), or a combination thereof. In embodiments, fluidic medium entering the apparatus 100 and/or heated therein comprises a non-oxidative gas, such as nitrogen gas (N₂), hydrogen gas (H₂), a hydrocarbon-containing gas, or any combination thereof. In embodiments, fluidic medium entering the apparatus 100 and/or heated therein comprises flue gases generated during feedstock conversion process(es) in the feedstock conversion facility and including at least carbon oxides, such as carbon monoxide (CO) and/or carbon dioxide (CO₂). In embodiments, fluidic medium entering the apparatus 100 and/or heated therein comprises a recycle gas recycled from exhaust gases generated during feedstock conversion process(es) in the feedstock conversion facility.

It is preferred that the apparatus 100 is supplied with a gaseous feed. This is achieved by providing (pre) heater device(s) 102, 202 before the apparatus 100 for heating gaseous feeds and/or converting of liquids into a gaseous form.

Flue gases generated in the feedstock conversion facility may be recycled into the apparatus 100, optionally through separation/purification unit or units 104, 204, 208, as described herein above.

In embodiments, the disclosed method comprises generation of a heated fluidic medium by at least one rotary apparatus integrated into a related feedstock conversion facility, the at least one rotary apparatus comprising: (a) a rotor with a plurality of rotor blades arranged into at least one row around a rotor hub mounted onto a rotor shaft; (b) a plurality of stationary blades or vanes arranged into an assembly adjacent to the at least one row of rotor blades; and (c) a casing with a duct formed between at least one inlet and at least one outlet, the duct configured to encompass rotating and stationary blades such that bladeless portion(s) of the duct is/are arranged essentially subsequently to bladed portions thereof, wherein the rotary apparatus is configured to impart an amount of thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated.

In the facility 1000, 2000, the rotary apparatus (-es) 100 can be retrofitted with existing equipment, such as furnaces, reactors and reactor systems, as described herein above.

Implementation of the rotary apparatus 100 may generally follow the disclosures of a rotary reactor apparatus according to the U.S. Pat. No. 7,232,937 (Bushuev), U.S. Pat. No. 9,494,038 (Bushuev) and U.S. Pat. No. 9,234,140 (Seppälä et al), and of a radial reactor apparatus according to the U.S. Pat. No. 10,744,480 (Xu & Rosic), the entire contents of which are incorporated by reference herewith. Any other implementation, which can be configured to adopt the method according to the embodiments, can be utilized.

In the patent documents referenced above, the rotary turbomachine-type apparatuses were designed as reactors for processing hydrocarbons, in particular, for steam cracking. General requirements for these applications are: rapid heating of gases, high temperature, short residence time, and plug flow (a flow model which implies no axial mixing). These requirements have led to designs where the turbomachine type reactors have several heating stages accommodated in a relatively small volume.

The present disclosure is based on an observation that the rotary apparatus (including, but not limited to the ones referenced above) can be used as a heater to generate the heated fluidic medium further supplied into thermal or thermochemical conversion processes related to recycling carbonaceous (waste) materials, such as plastics or organics, e.g. biomass, and producing valuable products. In some configurations, the apparatus 100 can be electrified. Hence, by integration of the rotary apparatus heater unit(s) into feedstock conversion process or processes, significant reductions in greenhouse gas- and particle emissions can be achieved.

The rotary apparatus 100 integrated into the feedstock conversion facility according to the embodiments and configured to generate the heated fluidic medium for the method(s) according to the embodiments thus comprises a rotor shaft positioned along a horizontal (longitudinal) axis with at least one rotor unit mounted onto the rotor shaft. The rotor unit comprises a plurality of rotor blades (also referred to as rotating or working blades) arranged over the circumference of a rotor hub or a rotor disk and together forming a rotor blade cascade. The rotary apparatus 100 thus comprises a plurality of rotor blades arranged into at least one row around the rotor hub or a rotor disk mounted onto the rotor shaft, and forming an essentially annular rotor blade assembly or rotor blade cascade.

In embodiments, the apparatus 100 further comprises a plurality of stationary blades or vanes arranged into an assembly adjacent to the at least one row of rotor blades. With the term “stationary” we refer to non-rotating blades/vanes (as contrary to the rotor blades). It is noted that attachment of stationary vanes to the casing (internal wall or lining thereof) may be fixed (non-movable) or essentially movable. In a latter case attachment of stationary vane (-s) may employ some degree of movement, allowing adjustment of the blade angle, to some extent, with regard to the rotor blades and/or the interior of the casing. Stationary blades/vanes may be attached directly to the casing (internal wall and/or lining thereof) or via auxiliary connector means such as for example rails, ring-shaped support frame, etc. Movable connection may be realized by hinged joints, or any other appropriate connection means.

In embodiments, said rotating and stationary blades are encompassed within an apparatus casing, in where a duct is formed, thus forming bladed portions of the duct. In embodiments, said rotating and stationary blades are arranged in the duct such that bladeless portions are formed, in the duct, essentially subsequently to stationary blades and/or rotating vanes. In embodiments, said bladeless portion(s) of the duct is/are arranged essentially subsequently to bladed portions thereof.

The rotary apparatus is thus configured to impart an amount of thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated.

In some embodiments, the plurality of stationary vanes can be arranged into at least one stationary vane cascade, provided as an essentially annular assembly upstream and/or downstream of the at least one row of rotor blades.

A plurality of stationary vanes arranged into the assembly disposed upstream of the at least one row of rotor blades may be provided as stationary guide vanes (GV), such as inlet guiding vanes (IGV), and be configured, in terms of profiles, dimensions and disposition thereof around the central shaft, to direct the fluid flow into the rotor in a predetermined direction such, as to control and, in some instances, to maximize the rotor-specific work input capability.

In embodiments, the rotary apparatus 100 further comprises a diffuser area arranged downstream of the at least one row of rotor blades (rotor blade cascade). The diffuser area can be configured with or without stationary (diffuser) vanes. Hence, the diffuser area may be provided as an essentially bladeless portion of the duct or as a bladed portion of the duct. In a latter case the diffuser area comprises a vaned diffuser implemented as a plurality of stationary blades or vanes arranged into a diffuser vane cascade, provided as an essentially annular assembly downstream of the rotor. In some configurations, the diffuser area may encompass a vaneless diffuser.

The rotary apparatus can be configured with two or more essentially annular rows of rotor blades (blade cascades) sequentially arranged on/along the rotor shaft. In such an event, the stationary guide vanes may be installed upstream of the first row of the rotor blades, upstream of each row of rotor blades in the sequence, or upstream of any selected row of rotor blades in a sequential arrangement of the latter; and the stationary diffuser vanes may be installed downstream of the first row of the rotor blades, downstream of each row of rotor blades in the sequence, or downstream of any selected row of rotor blades in a sequential arrangement of the latter.

The rotor and the stationary blades (IGV and/or diffuser blades) are enclosed within an internal passageway (the duct) formed in the casing.

The diffuser area provided as an essentially bladeless portion of the duct is described in more detail in U.S. Pat. No. 10,744,480 to Xu and Rosic. In such configuration, provision of the diffuser device (whether vaned or vaneless) may be omitted, and diffuser area may be represented with the essentially bladeless portion of the duct (a so-called vaneless space) located downstream of the rotor and configured, in terms of its geometry and/or dimensional parameters, to diffuse a high-speed fluid flow arriving from the rotor.

Overall, provision of the bladeless/vaneless portion of the duct is common for all configurations of the rotary apparatus 100 described above. Depending on configuration, said bladeless portion is arranged subsequently (downstream) to the rotor blades (rf. U.S. Pat. No. 10,744,480 to Xu and Rosic) or subsequently (downstream) to stationary diffuser blades (rf. U.S. Pat. No. 9,494,038 to Bushuev and U.S. Pat. No. 9,234,140 to Seppälä et al). In some configuration described for example by Seppälä et al, arrangement of rotating and stationary blade rows in the internal passageway within the casing is such that bladeless portion(s) is/are created between an exit from the stationary diffuser blades disposed downstream of the rotor blades and an entrance to the stationary guide blades disposed upstream of the rotor blades of a subsequent rotor blade cascade unit.

The terms “upstream” and “downstream” refer hereby to spatial and/or functional arrangement of structural parts or components with relation to a predetermined part- or component, hereby, the rotor, in a direction of fluidic flow stream throughout the apparatus (from inlet to exit).

In some configurations, the at least one row of rotor (working) blades can be positioned between the rows of stationary (stator) vanes arranged into essentially annular assemblies (referred to as cascades) at one or both sides of the working blade row. Configurations including two or more rows of rotor blades/rotor blade cascades arranged in series (in sequence) on/along the rotor shaft may be conceived with or without stationary blades in between. In an absence of stationary vanes between the rotor blade rows, the speed of fluidic medium propagating through the duct increases in each subsequent row. In such an event, a plurality of stationary vanes may be arranged into assemblies upstream of a first rotor blade cascade in said sequence (as stationary guide vanes) and downstream of a lastmost rotor blade cascade (as stationary diffuser vanes).

The row of rotor blades (rotor blade cascade) and a portion of the duct downstream said rotor blades enclosed inside the casing optionally provided with an assembly of stationary diffuser vanes (diffuser area) may be viewed as a minimal process stage (hereafter, the stage), configured to mediate a complete energy conversion cycle. Hence, an amount of kinetic energy added to the stream of fluidic medium by at least one row of rotating blades is sufficient to raise the temperature of the fluidic medium to a predetermined value when said stream of fluidic medium exits the rotor blades and propagates, in the duct, towards a subsequent row of rotor blades, or enters the same row of rotor blades following an essentially helical trajectory formed within the essentially toroidal-shaped casing. Hence, thermal energy is added to the stream of fluidic medium flowing in the duct between the at least one inlet and the at least one outlet by virtue of converting mechanical energy of rotating blades of the rotor into internal energy of the fluid (whereby thermal energy is added to the fluidic stream) when said fluidic stream successively passes through bladed and bladeless portions of the duct. The duct (which encloses the periphery of the rotor) is preferably shaped such, that upon propagation of the fluidic stream in the duct, the stream decelerates and dissipates kinetic energy into an internal energy of the fluidic medium, and an amount of thermal energy is added to the stream of fluidic medium.

The stationary guide blade row(s) disposed upstream of the at least one row of rotor blades prepare required flow conditions at the entrance of the rotating blade row (cascade) during the energy conversion cycle.

In some configurations, the process stage is established with the assembly of stationary guide vanes (upstream of the rotor blades), the row of rotor blades and the diffuser area arranged downstream of said rotor blades, the diffuser area provided as the essentially vaneless portion of the duct optionally supplied with diffuser vanes. During the energy conversion cycle, enabled with successive propagation of the stream of fluidic medium through the stationary guide vanes, the at least one row of rotor blades and the diffuser area, respectively, in a controlled manner, mechanical energy of the rotor shaft is converted into kinetic energy and further-into internal energy of the fluid, followed by the rise of fluid temperature. An amount of kinetic energy added to the stream of fluidic medium by rotating blades of the rotor is sufficient to raise the temperature of the fluidic medium to a predetermined value when said stream of fluidic medium exits the rotor blades and passes, inside n the duct, through the diffuser area, whereupon the stream decelerates and dissipates kinetic energy into an internal energy of the fluidic medium, and an amount of thermal energy is added to the stream of fluidic medium. In the rotor blade row, the flow accelerates, and mechanical energy of the shaft and rotating blades is transferred to fluidic stream. In at least part of each rotor blade row the flow may reach a supersonic flow condition. In the diffuser area, the high-speed fluid flow arriving from the rotor is diffused with the significant entropy increase, whereby the flow dissipates kinetic energy into the internal energy of the fluidic substance, thus providing thermal energy into the fluid. If the flow upstream of the diffuser is supersonic, the kinetic energy of the fluidic stream is converted into internal energy of the fluid through a system of multiple shocks and viscous mixing and dissipation. An increase in the internal energy of the fluid results in a rise of fluid temperature. The energy conversion function may be performed by the vaneless portion of the duct located downstream of the rotor blades (rf. U.S. Pat. No. 10,744,480 to Xu & Rosic) and/or by an assembly of diffusing vanes, for example (rf. U.S. Pat. No. 9,234,140 to Seppälä et al).

The rotary apparatus 100 can be configured as a multistage- or a single-stage solution. Multistage configurations can be conceived comprising a number of rotor units (e.g. 1-5 rows of rotor blades sequentially arranged on/along the rotor shaft) alternating with bladeless area(s). In some configurations, the bladeless area(s) may be referred to as (bladeless) diffuser areas. In some configurations, the bladeless area(s) (bladeless portions of the ducts) may be arranged subsequently to stationary blades, such as stationary diffuser blades.

In an exemplary configuration outlined in U.S. Pat. No. 9,234,140 to Seppälä et al, the rotary apparatus 100 can be implemented substantially in a shape of a ring torus, where a cross-section of the duct in the meridian plane forms a ring-shaped profile. The apparatus comprises a rotor unit disposed between stationary guide vanes (nozzle vanes), and stationary diffusing vanes. The stages are formed with rows of stationary nozzle vanes, rotor blades and diffusing vanes, through which the fluidic stream propagates, in a successive manner, following a flow path established in accordance with an essentially helical trajectory. In this configuration, fluidic stream circulates through the rotating rotor blade cascade a number of times while propagating inside the apparatus between the inlet and the exit. Similar ring-shaped configuration is described in U.S. Pat. No. 9,494,038 to Bushuev.

In another exemplary configuration outlined in U.S. Pat. No. 9,234,140 to Seppälä et al, the rotary apparatus 100 can be configured as an essentially tubular, axial-type turbomachine. In such configuration, the apparatus comprises an extended (elongated) rotor hub, along which a plurality of rotor blades is arranged into a number of sequential rows. The rotor is enclosed within the casing, inner surface of which is provided with the stationary (stator) vanes and diffuser vanes, arranged such that blades/vanes of the stator, rotor- and diffuser cascades alternate along the rotor hub in a longitudinal direction (along the length of the rotor shaft, for inlet to exit). Blades of the rotor cascade at certain position along the rotor in the longitudinal direction form the stage with the adjacent pairs of stationary guide (nozzle) vanes and diffusing vanes, respectively.

In described configurations, the subsequent stages have blade/vane-free space between them.

In still another exemplary configuration outlined in U.S. Pat. No. 10,744,480 to Xu and Rosic, the rotary apparatus 100 can be configured as a radial turbomachine that generally follows a design for centrifugal compressors or centrifugal pumps. The term “centrifugal” implies that fluid flow within the device is radial; therefore, the apparatus may be referred, in the present disclosure, as a “radial-flow apparatus. The apparatus comprises a number of rotor units mounted onto elongated shaft, wherein each rotor unit is preceded with stationary guide vanes. A vaneless portion of the duct shaped in a manner enabling energy conversion (U-bend or S-bend, for example) is located after the rotor unit(s). Additionally, configuration may comprise a separate diffuser device (vaned or vaneless) disposed downstream of the rotor.

In all configurations described above, the rotary apparatus 100 performs, in the method disclosed herein, in similar manner. In operation, input energy conducted into the at least one rotary apparatus integrated into the feedstock conversion facility is converted into mechanical energy of the rotor. Conditions in the rotary apparatus are adjusted such, as to produce flow rate conditions, at which an amount of kinetic energy added to the stream of fluidic medium by rotating blades of the rotor is sufficient to raise the temperature of the fluidic medium to a predetermined value when said stream of fluidic medium exits the at least one row rotor blades and passes through the duct and/or through the diffuser area to enter the subsequent row of rotor blades or the same row of rotor blades in accordance to the description above. The row(s) of rotor blades may be preceded with stationary guide vanes. Hence, adjustable conditions comprises adjusting at least a flow of fluidic medium propagating inside the casing of the rotary apparatus, between the inlet and the exit. Adjusting the flow may include adjusting such apparatus operation related parameters, as temperature, mass flow rate, pressure, etc. Additionally or alternatively, flow conditions can be adjusted by modifying shape of the duct formed inside the casing. It may be preferred that the rotary apparatus is operated at low pressure, such as for example 1-1.5 atm.

Also temperature of fluidic medium, propagating through working stages of the apparatus 100 can be optimized as required. In particular, temperature rise per stage may be optimized such to promote thermal decomposition of ammonia or methanol feedstocks in all stages or in selected stages. For example, the rotary apparatus 100 shown on FIG. 1A or the apparatus shown rotary 100-2 on FIG. 3A is adapted for implementing conversion/decomposition reactions, i.e. is rendered with a conversion reactor functionality. Apparatuses 100 (FIG. 1A) and 100-2 (FIG. 3A) can thus be configured with a number of working stages designated with a function of (pre) heating the feedstock-containing feed (ammonia or methanol, respectively) to a predetermined temperature. After the feedstock-containing process stream have passed three or four so-called (pre) heating stages, it typically reaches the temperature at which the feed starts to actively decompose. In practice, decomposition reactions may occur already after the process fluid has passed the first working stage. Working stages within a duct region, where actual conversion/decomposition reactions occur, are referred to as reactive stages.

In some configurations, the rotary apparatus 100 adapted to implement conversion/decomposition reactions of ammonia or methanol feedstocks to yield a hydrogen product (100, FIG. 1A or 100-2, FIG. 3A) may be equipped with an arrangement for extending residence time in reactive stages (not shown). Such an arrangement preferably comprises means for extraction of process fluid from the rotary apparatus and for intake of additional fluid into the apparatus between the reactive stage. Additional fluid may be any one of feed gas, a recycle gas, a make-up gas (a so-called replacement/supplement gas), a process fluid (transferred from a parallel apparatus for example), a dilution medium for any one of cooling/heating and the like. Said additional fluid is fed into the duct between the (reactive) stages. Fluid extraction/intake arrangement may be provided as pipelines or conduits in connection with appropriate liquid/gas sources (not shown). In some alternative or additional configurations, the extraction/intake arrangement may be configured as a heat exchanger, for example, to cool the process fluid. Cooling of the process within reactive stages may be used for further optimization of reaction yields.

In some exemplary configurations, the rotary apparatus can be configured to implement a fluidic flow between its inlet(s) and outlet(s) along a flow path established in accordance with any one of: an essentially helical trajectory formed within an essentially toroidal-shaped casing, as discussed in any one of the patent documents U.S. Pat. No. 9,494,038 to Bushuev and U.S. Pat. No. 9,234,140 to Seppälä et al; an essentially helical trajectory formed within an essentially tubular casing, as discussed in the patent document U.S. Pat. No. 9,234,140 to Seppälä et al; an essentially radial trajectory as discussed in the patent document U.S. Pat. No. 10,744,480 to Xu & Rosic; and along the flow path established by virtue of the stream of fluidic medium in the form of two spirals rolled up into vortex rings of right and left directions, as discussed in the patent document U.S. Pat. No. 7,232,937 to Bushuev). The aerodynamic design of the rotary apparatus can vary.

The rotary apparatus 100 utilizes a drive engine. In some configurations, the apparatus utilizes electrical energy as input energy and is therefore electric motor-driven. For the purposes of the present disclosure, any appropriate type of electric motor (i.e. a device capable of transferring energy from an electrical source to a mechanical load) can be utilized. Suitable coupling(s) arranged between a motor drive shaft and the rotor shaft, as well as various appliances, such as power converters, controllers and the like, are not described herewith. Additionally, the apparatus can be directly driven by gas- or steam turbine, for example, or any other appropriate drive device. In layouts involving parallel connection of a number of rotary apparatuses 100 to a common feedstock conversion device, such as a reactor or a furnace, for example (not shown), one or more of said apparatuses may utilize different type of drive engine, e.g. the electric motor driven apparatuses can be combined with those driven by steam turbine, gas turbine and/or gas engine.

An amount of input energy Eₗ may thus be conducted into the at least one rotary apparatus 100 integrated, as a (rotary) heater unit, into the conversion facility 1000, 2000. The input energy Eₗ may comprise electrical energy supplied from external or internal source (as related to the rotary apparatus itself and/or the conversion facility. Electrical input energy El supplied into the apparatus can be defined in terms of electric power, the latter being defined as a rate of energy transfer per unit time (measured in Watt). Electric power can be supplied into the rotary apparatus through supplying electric current to the electric motor used to propel a rotary shaft of the apparatus.

Electric power can be supplied from an electricity generating system that exploits at least one source of renewable energy or a combination of the electricity generating systems exploiting different sources of renewable energy. External sources of renewable energy can be provided as solar, wind- and/or hydropower. Thus, electric power may be received into the process from at least one of the following units: a photovoltaic electricity generating system, a wind-powered electricity generating system, and a hydroelectric power system. In some exemplary instances, a nuclear power plant may be provided as the external source of electrical power. Nuclear power plants are generally regarded as emission-free. The term “nuclear power plant” should be interpreted as using traditional nuclear power and, additionally or alternatively, fusion power.

Electricity can be supplied from a power plant that utilizes a turbine as a kinetic energy source to drive electricity generators. In some instances, electric power to drive the at least one apparatus 100 can be supplied from at least one gas turbine (GT) provided as a separate installation or within a cogeneration facility and/or a combined cycle power facility, for example. Electric power can thus be supplied from at least one of the following units: a combined cycle power facility, such as a combined cycle gas turbine plant (CCGT), and/or a cogeneration facility configured for electricity production combined with heat recovery and utilization through combined heat and power (CHP), for example. In some examples, the CHP plant can be a biomass fired plant to increase the share of renewable energy in the process described. Additionally or alternatively, supply of electric power can be realized from a spark ignition engine, such as a gas engine, for example, and/or a compression engine, such as a diesel engine, for example, optionally provided as a part of an engine power plant. Still further, any conventional power plant configured to produce electrical energy from fossil raw materials, such as coal, oil, natural gas, gasoline, and the like, typically mediated with the use of steam turbines, can be used to generate electrical energy as an input energy for the rotary apparatus 100. Also hydrogen can be utilized as a source of renewable energy, to be reconverted into electricity, for example, using fuel cells.

Any combination of the abovementioned sources of electric power, realized as external and internal sources, may be conceived. Importing low emission electric power from an alternative (external) source improves energy efficiency of the feedstock conversion facility.

Conducting input energy, comprising electrical power, into a drive engine of the rotary apparatus can be further accompanied with conducting mechanical shaft power thereto from a power turbine, for example, optionally utilizing thermal energy generated elsewhere in the facility 1000 or outside said facility. Shaft power is defined as mechanical power transmitted from one rotating element to another and calculated as a sum of the torque and the speed of rotation of the shaft. Mechanical power is defined, in turn, as an amount of work or energy per unit time (measured in Watt).

In practice, the shaft power from the electric motor and the power turbine, for example, can be divided so that any one of those can provide the full shaft power or a fraction of it.

In embodiments, the disclosed method comprises generation of the heated fluidic medium by at least two rotary apparatuses integrated into the feedstock conversion facility, said at least two rotary apparatuses being connected in parallel or in series (connection in series is shown on FIGS. 3A and 3C with 100-1 and 100-2).

Upon connecting the at least two rotary apparatuses in parallel or in series, a rotary apparatus assembly can be established. Connection between rotary apparatuses in the assembly may be mechanical and/or functional. Functional (in terms of achievable heat input, for example) connection can be established upon association between at least two individual, physically integrated- or non-integrated individual apparatus units. In a latter case, association between the at least two rotary apparatuses can be established via a number of auxiliary installations (not shown). In some configurations, the assembly comprises the at least two apparatuses connected such, as to mirror each other, whereby said at least two apparatuses are at least functionally connected via their central (rotor) shafts. Such mirrored configuration can be further defined as having the at least two rotary apparatuses 100 mechanically connected in series (in a sequence), whereas functional connection can be viewed as connection in parallel (in arrays). In some instances, the aforesaid “mirrored” arrangement can be further modified to comprise at least two inlets and a common exhaust (discharge) module placed essentially in the center of the arrangement.

A number of rotary apparatuses can be assembled on the same (rotor) shaft (not shown). Each rotary apparatus can be optionally provided with a separate drive (a motor) which allows independent optimization of the apparatuses. When two or more separate rotary apparatuses are used, construction costs (materials etc.) can be optimized in view of operation temperature and pressure.

In an event two rotary apparatus are connected in sequence, a first apparatus in the sequence may serve as a primary heater and a second one—as a so-called booster heater (to further raise temperature of fluids heated in the primary apparatus optionally by injecting reactive chemicals thereto).

In an aspect, a feedstock conversion facility 1000 (1000A, 1000B), 2000 (2000A-2000D) is provided, comprising at least one reactor or furnace configured to convert ammonia or methanol feedstocks to hydrogen at temperatures essentially equal to or exceeding about 500 degrees Celsius (° C.) and at least one rotary apparatus configured to generate a heated fluidic medium for inputting thermal energy into said at least one reactor or furnace, the at least one rotary apparatus comprising: (a) a rotor with a plurality of rotor blades arranged into at least one row around a rotor hub mounted onto a rotor shaft; (b) a plurality of stationary blades or vanes arranged into an assembly adjacent to the at least one row of rotor blades; and (c) a casing with a duct formed between at least one inlet and at least one outlet, the duct configured to encompass rotating and stationary blades such that bladeless portion(s) of the duct is/are arranged essentially subsequently to bladed portions thereof, wherein, in said facility, the at least one rotary apparatus is configured to operate such that thermal energy is imparted to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated.

In embodiments, the feedstock conversion production facility is configured as hydrogen production facility. In embodiments, the hydrogen production facility is configured to implement the feedstock conversion method according to the embodiments described herein above.

In embodiments, the feedstock conversion production facility is an ammonia cracking plant optionally implemented at steam cracking conditions or a methanol steam reforming (MSR) plant.

It is clear to a person skilled in the art that with the advancement of technology the basic ideas of the present invention may be implemented and combined in various ways. The invention and its embodiments are thus not limited to the examples described herein above, instead they may generally vary within the scope of the appended claims.

1. A method for thermal or thermochemical conversion of ammonia or methanol feedstocks into hydrogen, the method comprising generation of a heated fluidic medium by at least one rotary apparatus integrated into a related feedstock conversion facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
supplying the stream of heated fluidic medium generated by the at least one rotary apparatus into the feedstock conversion facility, and
operating said at least one rotary apparatus and said feedstock conversion facility to carry out thermal or thermochemical conversion of ammonia or methanol feedstocks into hydrogen at temperatures essentially equal to or exceeding about 500 degrees Celsius (° C.).

2. The method of claim 1, wherein, in the feedstock conversion facility, the at least one rotary apparatus is connected to at least one feedstock conversion device configured to carry out thermal or thermochemical conversion of ammonia or methanol feedstocks into hydrogen at temperatures essentially equal to or exceeding about 500 degrees Celsius (° C.).

3. The method of claim 1, comprising supplying the stream of heated fluidic medium generated by at least one rotary apparatus into at least one feedstock conversion device within the feedstock conversion facility.

4. The method of claim 1, wherein the feedstock conversion device comprises an at least one reactor or a furnace configured to carry out thermal and/or catalytic processes to generate hydrogen from ammonia or methanol.

5. The method of any claim 1, comprising generating a heated fluidic medium in the at least one rotary apparatus by virtue of adding thermal energy to the fluidic medium propagating therethrough, and using said fluidic medium as a carrier to transfer thermal energy to at least one feedstock conversion device and to heat the stream of ammonia or methanol feedstock-containing process fluid in said feedstock conversion device to the temperature(s), at which conversion reactions occur.

6. The method of claim 1, comprising subjecting ammonia or methanol feedstocks to thermal or thermochemical conversion in the at least one rotary apparatus, wherein conversion reactions are initiated in a stream of ammonia or methanol feedstock-containing process fluid propagating through the rotary apparatus by virtue of adding thermal energy required for conversion reactions to occur directly to the stream of said feedstock-containing process fluid.

7. The method of claim 1, wherein thermal or thermochemical conversion of ammonia or methanol feedstocks is carried out by pyrolysis and/or by reforming, optionally in presence of steam.

8. The method of claim 1, comprising generation, by at least one rotary apparatus, of the fluidic medium heated to the temperature essentially equal to or exceeding about 500 degrees Celsius (° C.).

9. The method of claim 1, comprising supplying the stream of heated fluidic medium generated by the at least one rotary apparatus into the feedstock conversion facility to provide external heat to at least one feedstock conversion device within said facility.

10. The method of claim 6, wherein the heated fluidic medium generated by the at least one rotary apparatus comprises ammonia (NH₃) or methanol (CH₃OH).

11. The method of claim 1, wherein the fluidic medium that enters into the at least rotary apparatus is an essentially gaseous medium.

12. The method of claim 1, wherein the heated fluidic medium generated in the at least one rotary apparatus comprises any one of air, oxygen gas (O₂), nitrogen gas (N₂), nitrogen oxide (NOₓ), hydrogen gas (H₂), carbon dioxide (CO₂), carbon monoxide (CO), a hydrocarbon-containing gas, or a combination thereof.

13. The method of claim 1, wherein the heated fluidic medium generated in the at least one rotary apparatus comprises steam (H₂O).

14. The method of claim 1, wherein the heated fluidic medium generated by the at least one rotary apparatus comprises a recycle gas recycled from exhaust gases generated during feedstock conversion process(es) in the feedstock conversion facility.

15. The method of claim 2, wherein the feedstock conversion device comprises a pyrolysis reactor or a reforming reactor.

16. The method of claim 15, wherein the feedstock conversion device comprises at least one packed bed reactor.

17. The method of claim 15, wherein the feedstock conversion device comprises catalyst.

18. The method of claim 1, comprising adjusting velocity and/or pressure of the stream of fluidic medium propagating through the rotary apparatus.

19. The method of claim 1, wherein the heated fluidic medium is generated by at least one rotary apparatus comprising two or more rows of rotor blades sequentially arranged along the rotor shaft.

20. The method of claim 1, wherein the heated fluidic medium is generated by at least one rotary apparatus, in which the bladeless portion of the duct is arranged downstream of the at least one row of rotor blades.

21. The method of claim 1, comprising connecting at least two rotary apparatuses into a system, in which a first apparatus is rendered with a preheater function to (pre) heat the ammonia or methanol feedstock-containing process fluid, and a second apparatus arranged downstream of the first apparatus is rendered with a thermal cracker function.

22. The method of claim 1, wherein the at least one rotary apparatus is electrically operated and wherein electrical energy constitutes 5 to 100 percent of a total energy consumption by said at least one rotary apparatus.

23. The method of claim 1, wherein electrical energy consumed by the at least one rotary apparatus is obtainable from a source of renewable energy or a combination of different sources of energy, optionally, renewable energy.

24. The method of any claim 1, wherein the at least one rotary apparatus is configured to receive input energy from a non-electric power source, such as a power turbine and/or a mechanical drive engine.

25. The method of claim 1, wherein the feedstock conversion production facility is a hydrogen production facility.

26. The method of claim 25, wherein the feedstock conversion production facility is an ammonia cracking plant or a methanol steam reforming (MSR) plant.

27. A hydrogen production facility comprising at least one reactor or furnace configured to produce hydrogen from ammonia or methanol feedstocks at temperatures essentially equal to or exceeding about 500 degrees Celsius (° C.) and at least one rotary apparatus configured to generate a heated fluidic medium for inputting thermal energy into said at least one reactor or furnace, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the at least one rotary apparatus is configured to operate such that thermal energy is imparted to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated.

28. A hydrogen production facility comprising at least one reactor or furnace configured to produce hydrogen from ammonia or methanol feedstocks at temperatures essentially equal to or exceeding about 500 degrees Celsius (° C.) and at least one rotary apparatus configured to generate a heated fluidic medium for inputting thermal energy into said at least one reactor or furnace, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the at least one rotary apparatus is configured to operate such that thermal energy is imparted to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, wherein the hydrogen production facility is configured to implement a method according to claim 1.

29. A method for producing hydrogen from ammonia or methanol, the method comprising generation of a heated fluidic medium by at least one rotary apparatus integrated into a related hydrogen production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
supplying the stream of heated fluidic medium generated by the at least one rotary apparatus into the hydrogen production facility, and
operating said at least one rotary apparatus and said hydrogen production facility to carry out thermal or thermochemical conversion of ammonia or methanol into hydrogen at temperatures essentially equal to or exceeding about 500 degrees Celsius (° C.).

30. A method for producing hydrogen from ammonia or methanol, the method comprising generation of a heated fluidic medium by at least one rotary apparatus integrated into a related hydrogen production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
supplying the stream of heated fluidic medium generated by the at least one rotary apparatus into the hydrogen production facility, and
operating said at least one rotary apparatus and said hydrogen production facility to carry out thermal or thermochemical conversion of ammonia or methanol into hydrogen at temperatures essentially equal to or exceeding about 500 degrees Celsius (° C.), wherein production of hydrogen from ammonia or methanol feedstocks is implemented, in the hydrogen production facility, via a thermal or thermochemical conversion method defined in claim 1.
